(19) United States
(12) Patent Application Publication
(10) Pub. No.: US 2005/0156046 A1
(43) Pub. Date: Jul. 21, 2005

(54) Method and apparatus for validation/identification of flat items

(75) Inventor: Lior Goldenberg, Holon (IL)

Correspondence Address: G.E. EHRLICH (1995) LTD.;c/o ANTHONY CASTORINA, SUITE 207, 2001 JEFFERSON DAVIS HIGHWAY, ARLINGTON, VA, 22202, US

(73) Assignee: Beyong Technologies Ltd.

(21) Appl. No.: 10/757,488

(22) Filed: Jan. 15, 2004

(51) Int. Cl. G06K 7/10; G06K 15/00

(52) U.S. Cl. 235/462.13

(57) ABSTRACT

Apparatus or method for identifying and/or validating stacked substantially flat items, comprises: stacking items having markings identifiable from an edge, viewing said stack from at least one angle selected so that edges of said items are in view, capturing an image from said at least one angle, carrying out image processing over said image to produce at least one output indicative of one of edges and edge markings in view, and using said output to obtain information of items in said stack. The items may have edge-on viewable markings that identify themselves individually or as part of a given set or both.

### FIELD AND BACKGROUND OF THE INVENTION

The present invention relates to a method and apparatus for image-based validation of sets of substantially flat items in a stack, and more particularly, but not exclusively to an apparatus or method for counting currency, tickets and the like in a stack or identifying individual items within the stack such as credit cards of individual users, validating groups of such individually identifiable items, or identifiable sets of identical items such as a deck of cards.

There are a number of methods for automatic counting of stacked paper or card items such as banknotes and voting slips. Most rely on flipping through the stack and fail when two items stick to each other. Another disadvantage is that a delay ensues as it takes time to mechanically flick through the entire stack. An example of such a device is the Model 35 Currency Counter supplied by Magner Corporation of America, of 41 West Street Middlefield, Conn. 06455 USA, which accommodates notes of at least a minimum note size and thickness and no more than a maximum note size and thickness. The Model 35 leafs through the banknotes using friction in order to determine the number of banknotes.

Reference is also made to U.S. Pat. No. 6,530,525 assigned to De La Rue International Limited, which discloses a sheet counting apparatus includes a set of rotatably mounted suction spindles mounted for movement past a stack of sheets to be counted. A vacuum is connected to the spindles. As a suction spindle passes the stack, the vacuum is supplied to the spindle so that the topmost sheet is deflected from its initial position. A monitor monitors the number of deflected sheets by monitoring the degree of vacuum within the suction spindle passing the stack. The monitor increments a count on each occasion when the monitored vacuum exceeds a predetermined level threshold for a predetermined time.

In order to overcome the problems involved in mechanical flipping, a number of developments use entirely electronic signals including image processing in order to count the items in the stack.

U.S. Pat. Re. No. 27,869 to Willits et al describes apparatus for counting stacked sheets having no sheet separation requirements. The active area of a sensor array is matched to the width of a sheet and the sensor array traverses the stack. The signal output of the sensor array is stripped of unwanted components in a high gain, diode clamped capacitive input operation amplifier whose square wave output is processed and counted by a counting circuit.

U.S. Pat. No. 5,005,192 to Duss describes a system for counting flat items in a stream of partially overlapping items which are conveyed past a locus of impingement of ultrasonic waves.

U.S. Pat. No. 4,694,474 to Dorman et al describes a device for counting a stack of thin objects in which light is directed at the stack and a light sensor generates a signal proportional to the light reflected by the stack.

U.S. Pat. No. 5,040,196 to Woodward describes an instrument for counting stacked elements which images a portion of the side of the stack and then autocorrelates the image, while the instrument is stationary, and then cross-correlates the image as the instrument is moved. The result is a time varying signal whose repeating cycles, when counted, indicate the number of elements in the stack.

U.S. Pat. No. 3,971,918 to Saito counts stacked corrugated cardboards by scanning an end of the stack horizontally and vertically, using an array of photodiodes switched in turn by electric pulses. The outputs of the photodiodes are counted and compared to successively detect flat and corrugated sheets.

U.S. Pat. No. 4,912,317 to Mohan et al describes apparatus for counting stacked sheets whose apparent brightness is not uniform. The Mohan et al system normalizes the phase polarity of the sensor signal differential output, thereby avoiding the effects of brightness polarity reversals in the sensor output data. Mohan et al employs sensors whose effective imaged width on the stacked objects is very narrow relative to the individual objects. The data is differentially summed, then rectified to normalize phase polarity.

U.S. Pat. No. 5,324,921 describes a conventional sheet counting machine in which a photosensor is disposed across a bill passage downstream of a pulley. Emitted light is interrupted by each bill passing throughout the light path and therefore the number of bills can be counted by counting the number of intervals during which light is not received by the light receiver.

A general text on image processing is Pratt, W. K, Digital image processing, Second Ed., Wiley 1991, New York.

U.S. Pat. No. 5,534,690 discloses a method and apparatus for rapidly, accurately and inexpensively counting stacked objects, preferably by imaging, from below, a stack of flat objects which is standing on its side, preferably on its long side. The objects need not be identical in surface appearance or in configuration. The objects preferably may be of substantially any size or thickness and need not be less than some maximum size or within some narrow range of thicknesses.

Whilst the above devices are able to count the number of items in a stack of flat objects, such as a pile of papers, the citation contains no disclosure of how to identify individual items within the stack and/or determine whether the items belong or do not belong to a set. In particular there is no disclosure in the context of the above citation of how to make such a determination whilst viewing the stack edge on.

The disclosures of all of the above publications and of the references cited therein are hereby incorporated by reference.

There is thus a widely recognized need for, and it would be highly advantageous to have, a device and method devoid of the above limitations.

### SUMMARY OF THE INVENTION

According to one aspect of the present invention there is provided a method of validating stacked substantially flat items, comprising:
stacking items having markings identifiable from an edge,
viewing said stack from at least one angle selected so that said markings of said items are in view,
capturing an image from said at least one angle,
carrying out image processing over said image to produce at least one output indicative of one of edges and edge markings in view, and
using said output to obtain information of items in said stack.

Preferably, the method comprises carrying out said viewing of said stack under predetermined illumination conditions.

In one embodiment the method comprises viewing said stack under at least first illumination conditions to obtain a first output indicative of a number of items, and viewing said stack under at least second illumination conditions to obtain a second image indicative of said markings.

Preferably, one of said illumination conditions comprises illumination under visible light and a second of said illumination conditions comprises illumination under ultra-violet light.

Preferably, a plurality of said items belong to a respective set, and wherein said markings comprise corresponding markings applied to each item of a respective set, thereby to allow items not belonging to said respective set to be readily identifiable. Preferably, said edge markings are unique to individual items.

Preferably, correspondence between edge markings comprises respective edge marks in said sets having corresponding lengths.

Additionally or alternatively, correspondence between edge markings comprises respective edge marks in said sets having corresponding positions along respective edges.

Additionally or alternatively, correspondence between edge markings comprises respective edge marks in said sets having corresponding colors under predetermined illumination conditions.

Additionally or alternatively, correspondence between edge markings comprises respective edge marks in said sets having corresponding intensities under predetermined illumination conditions.

Additionally or alternatively, correspondence between edge markings comprises respective edge marks in said sets having corresponding patterns.

The edge markings may comprise a one-dimensional or two-dimensional bar code. In certain cases, the flat items are of rectangular (including square) shape, allowing four orientations within a stack, and the markings are equally visible from any given viewing angle irrespective of which of said four orientations a respective item assumes. Typically this is achieved by locating markings on each of the edges.

In an embodiment, said edge markings comprise an ink viewable only under predetermined illumination conditions.

In one embodiment, the items belong to sets, and, typically, each set has a predetermined number of members.

Preferably, said determining whether said set is valid comprises determining that said predetermined number of items is present and that each item present has markings corresponding to said set. In certain cases a respective stack comprises items belonging to a plurality of sets, and said determining comprises determining that a total number of items is present which number corresponds to said predetermined number for each of said sets totaled together, and wherein each of said items has markings corresponding to one of said plurality of sets.

The method may comprise producing a foreign item output indicating the presence of an item not belonging to said set.

Preferably, said foreign item output additionally indicates a location of said item not belonging to said set.

The items can for example be paper or cardboard or plastic items.

The items may have thicknesses in the sub-millimeter of a millimeter order of magnitude.

The image processing may comprise image enhancement and item detection.

Preferably, said image processing comprises detection of bars and spaces within said edge markings.

Preferably, said sets are decks of playing cards.

Preferably, said items are flat monetary-value-bearing items.

Preferably, said items are any of credit cards, debit cards, smart cards, electronic purses, checks, travelers checks, banknotes, bonds, identity cards, driving licenses, passports, passport pages, security paper, official documents, membership cards, travel cards, tickets and playing cards.

In an embodiment, said items have at least two oppositely facing edges and complementary edge markings on each of said oppositely facing edges so that an orientation of said item is detectable.

According to a second aspect of the present invention there is provided a set of items, each item in said set having edges, and a marking on at least one of said edges and viewable edge on, respective markings corresponding within said set so that items can be identified as belonging or not belonging to said set on the basis of said marking.

Preferably, said marking is visible only under predetermined illumination conditions.

Preferably, said marking is invisible under illumination over the visible part of the spectrum.

Preferably, each item has at least two oppositely facing edges and wherein markings are placed on each of said oppositely facing edges.

The item, or set of items may include complementary markings on each of said oppositely facing edges.

In the set, each item has at least four edges, and markings may be placed on at least two of said edges.

Preferably, each of the markings on at least two of said edges are identical.

Preferably, each of said markings on at least two of said edges are complementary.

Preferably, correspondence comprises a position of said marking along a respective edge.

Additionally or alternatively, correspondence comprises a length of said marking along a respective edge.

Additionally or alternatively, correspondence comprises a color of said marking under given illumination conditions.

Additionally or alternatively, correspondence comprises an intensity of said marking under given illumination conditions.

Additionally or alternatively, correspondence comprises a pattern.

Preferably, said marking comprises a barcode According to a third aspect of the present invention there is provided a stack processing apparatus comprising:
a holder for holding a stack of substantially flat items extending in a planar direction and having edges, said stack extending vertically from said planar direction, and at least one of said items comprising a marking at one of said edges,
an illumination unit for illuminating said stack under predetermined illumination conditions from an angle at which said edge-on markings on edges of said items can be illuminated, an image capture unit for viewing said stack from an angle at which said edge-on markings can be detected so as to view said items edge on and capture an image thereof, and
an image processing unit for processing said image to obtain data from said edges and said illuminated markings.

Preferably, said image processing apparatus is operable to use said data to determine a total number of items in said stack and to identify said items from said edge-on visible markings.

Preferably, said illumination unit is configured to provide a predetermined illumination condition.

Preferably, said illumination unit is configured for providing at least two illumination conditions, comprising first illumination conditions to obtain a first image indicative of edges, and second illumination conditions to obtain a second image indicative of edge markings.

Preferably, one of said illumination conditions comprises illumination under visible light and a second of said illumination conditions comprises illumination under ultra-violet light.

Preferably, said items are organized in sets, and wherein said markings correspond between each item of a respective set, thereby to allow items belonging to said respective set to be readily identifiable.

Preferably, correspondence between edge markings comprises respective edge marks in said sets having corresponding lengths.

Preferably, correspondence between edge markings comprises respective edge marks in said sets having corresponding positions along respective edges.

Preferably, correspondence between edge markings comprises respective edge marks in said sets having corresponding colors under predetermined illumination conditions.

Preferably, correspondence between edge markings comprises respective edge marks in said sets having corresponding patterns.

Preferably, said edge markings comprise a barcode.

Preferably, said items are of rectangular shape, allowing four orientations within a stack, and wherein said edge markings are arranged such that markings are equally visible from any given viewing angle irrespective of which of said four orientations a respective item assumes.

Preferably, each set has a predetermined number of members.

Preferably, said image processor comprises a validator for using said image processing to determine whether item sets are valid, and wherein said determining whether said set is valid comprises determining that said predetermined number of items is present and that each item present has markings corresponding to said set.

Preferably, a respective stack comprises items belonging to a plurality of sets, and said determining comprises determining that a total number of items is present, which number corresponds to said predetermined number for each of said sets totaled together, and wherein each of said items has markings corresponding to one of said plurality of sets.

The apparatus may also produce a foreign item output indicating the presence of an item not belonging to a respective set.

Preferably, said foreign item output additionally indicates a location of said item not belonging to said respective set.

The image processor may be adapted to carry out item detection.

Preferably, said item detection comprises image enhancement.

The items may be playing cards being parts of decks.

The items may have at least two edges and complementary edge markings on each of said oppositely facing edges, said image processor being able to use said complementary markings to detect an orientation of said item within said stack.

According to a fourth aspect of the present invention there is provided a method of modifying substantially flat items having faces and edges, for identification of respective items whilst stacked, comprising:
providing said substantially flat items, and
applying markings along at least one edge of each item.

Preferably, said marking is provided to a respective face such as to be visible from an edge under at least predetermined illumination conditions.

Preferably, said marking is applied to one of said edges of said item.

Preferably, said marking is not visible under illumination from the visible part of the spectrum.

Preferably, each item has at least two oppositely facing edges and comprising providing complementary marks on said at least two oppositely facing edges so that an orientation of said item within a stack is detectable.

Preferably, said items belong to sets, and comprising providing corresponding marks to each item within a given set and non-corresponding marks for different sets.

The method may comprise providing each item in the same set with a mark having a corresponding length.

The method may comprise providing each item in the same set with a mark having a corresponding position on said edge.

The method may comprise providing each item in the same set with a mark having a corresponding color under given illumination conditions.

The method may comprise providing each item in the same set with a mark having a corresponding intensity under given illumination conditions.

The method may comprise providing each item in the same set with a mark having a corresponding pattern.

Preferably, said pattern comprises a barcode.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram showing a card encoded according to an embodiment of the present invention;

FIG. 2 is a simplified diagram illustrating a set of items in a stack, encoded according to the embodiment of FIG. 1;

FIG. 3 illustrates an encoding scheme for providing distinctive markings for eight decks in accordance with a preferred embodiment of the present invention;

FIG. 4 illustrates an encoding scheme for providing distinctive markings to a large number of decks in accordance with a preferred embodiment of the present invention;

FIG. 5 is a simplified flow chart illustrating a procedure for validating a set of items in accordance with a preferred embodiment of the present invention;

FIG. 6 is an exemplary image of a stack taking from the side showing images of the items according to a preferred embodiment of the present invention;

FIG. 7 is the image of FIG. 6 after undergoing image enhancement and item detection;

FIG. 8 is an exemplary image of edge markings in a stack of items according to a preferred embodiment of the present invention;

FIG. 9 is the image of FIG. 8 after undergoing image enhancement and detection;

FIG. 10 is a simplified diagram illustrating apparatus for validating a stack of flat items according to a preferred embodiment of the present invention,

FIG. 11 is a flow chart showing a procedure for validating a stack of items belonging to sets, for example decks of cards, according to a preferred embodiment of the present invention, and

FIG. 12 is a flow chart similar to that of FIG. 11, but showing a procedure for validating individual items in a stack, the items not necessarily belonging to a set.

### DESCRIPTION OF THE PREFERRED EMBODIMENTS

The present embodiments comprise a device and method for automatically processing a stack of items when viewing the stack from the side, that is viewing the items edge on. The embodiments use image processing to gather information from the edge-on view of the stacked items. The items preferably include information that can be viewed edge-on, for example lines of given lengths or patterns of lines and spaces. The embodiments thus allow a stack of credit cards, smart cards, playing cards, and like stackable items, to be imaged with the result that individual cards in the stack can be identified.

Alternatively or additionally, the stack may be of a set of items that belong together and imaging may be used to confirm that all the items in the stack indeed belong to the set or alternatively to locate and identify stranger items or determine that items are missing from the set. In one embodiment, the markings are invisible to normal illumination, and are viewed under UV or like illumination.

The encoding information may be explicitly added to the items or alternatively, information visible from the side may already be present on the item. Thus for example the metallic or plastic strip on paper currency is visible from the edge. In some cases the position or size of the strip along the edge indicates the denomination of the currency. Again in some cases the color of the strip under UV illumination indicates the denomination of the currency.

The principles and operation of a set validation device and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

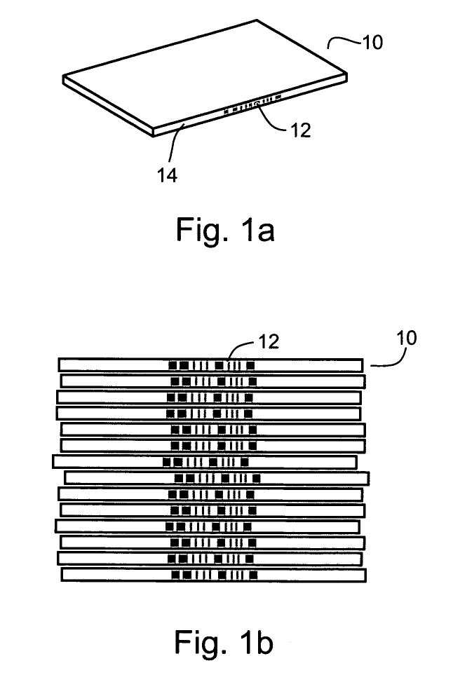

Reference is now made to FIG. 1A, which illustrates a flat stackable item 10 with an edge marking 12 according to a preferred embodiment of the present invention located on a first edge 14. The edge marking may, in a first preferred embodiment, be a simple line of a given length. The length may be different for different items, thereby enabling the items to be distinguished. In an alternative embodiment, the marking may comprise two or more lines with one or more spaces in between. The lengths of the lines or of the spaces and their order of appearance may be defined as part of the identification of the item, in the same way as with a standard barcode

Reference is now made to FIG. 1B which shows a series of flat items 10 arranged in a stack. The edges 14 are all visible from the side of the stack and thus the markings 12 are also visible.

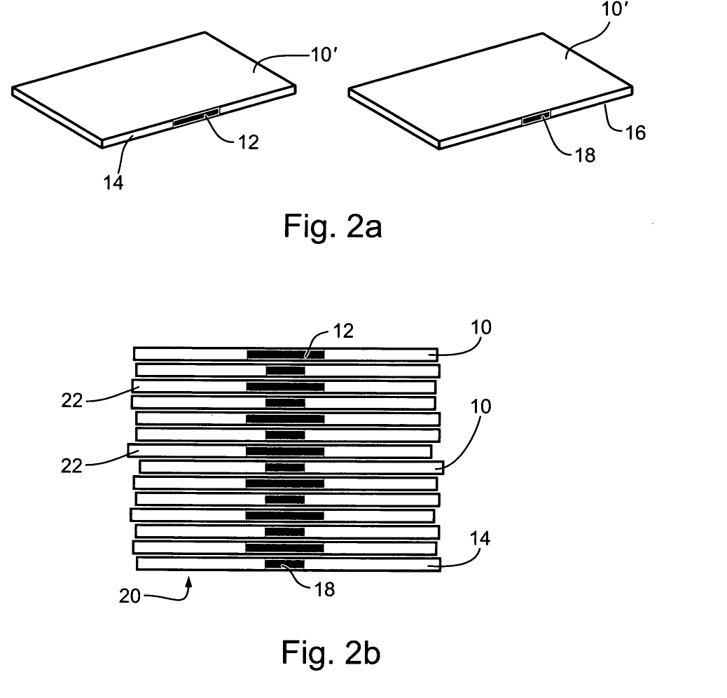

Reference is now made to FIG. 2A, in which flat stackable item 10 has marking 12 on first edge 14 as before. In addition, the item has a second edge 16 carrying a second marking 18. The second marking 18 may in one embodiment be identical to first marking 12, and is simply provided so that the item can be still identified if stacked the other way around. In an alternative embodiment the second marking 18 is different from first marking 12 so that the orientation of the item within the stack can be determined. In one preferred embodiment the two markings 12 and 18 are complementary. In the present context the term “complementary” simply indicates that the two different signs are signs that are paired together in some manner so that the system is able to conclude that the two signs belong to the same item. The complementary signs are printed on opposite edges of the items so that orientation information about the cards is available. In one embodiment, in which all items in a set are intended to be identical then all the items have the same pair or pairs of marks and therefore are indistinguishable. Indistinguishability is important in certain applications, such as playing cards. In the case of playing cards it is clear that no player should be able to learn the rank of a card by looking at the edge. Each card in the same deck needs to be identical, yet even if identical marks are placed on each of the cards in the deck, the deck itself can be validated.

Reference is now made to FIG. 2B, which shows a stack 20 of items 10′ in various orientations and viewed edge on. Each item in the stack has edges 22, which are visible when viewing the stack side on, and each item has a marking on one of the edges, preferably on two of the edges. In the figure all of the items belong to a set, and the markings on the different items correspond as long as the items indeed belong to the same set. The items can thus be identified as belonging or not belonging to any individual set on the basis of the marking. As shown in the figure, the stack has two complementary markings, 12 and 18, and one of the pair of complementary markings is visible for each item. The fact that more than one of the pair is visible over the stack shows that not all of the stacked items are of the same orientation.

The arrangement thus allows detection of items that are flipped or rotated, should this be of interest, as well as items that do not belong in the set.

The marking may be visible to the naked eye, but as an alternative, the marking may use an ink which is visible only under predetermined illumination conditions and is substantially invisible under general illumination over the visible part of the spectrum.

The marking may for example be a fluorescent marking, so that is only visible when illuminated by the correct wavelengths. The marking may be one that is visible only under ultraviolet light. Alternatively or additionally, the marks are visible only under ultra violet light and otherwise invisible. For instance the lines may be printed using a stable ultra violet fluorescent ink. In one embodiment the pattern can be negative, meaning that the edge is printed except for the lines.

Numerous properties of the mark may be used as part of the encoding, for example the code could be based on the position of marking along edge 22, and/or the length of the marking along the edge 22, or the color of the marking under given illumination conditions, or the intensity under given illumination conditions or a pattern such as lines and spaces, thus two lines interspersed by one space, three lines interspersed by two spaces, four lines interspersed by three spaces etc.

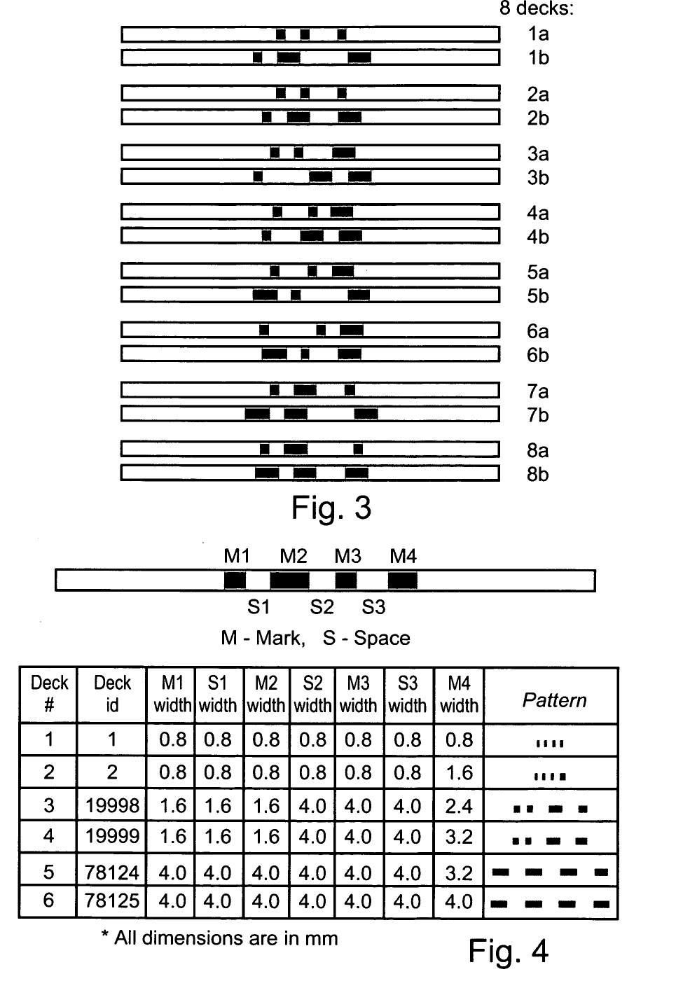

Reference is now made to FIG. 3, which shows a scheme for marking eight different sets of items, for example decks of playing cards. For each set 1-8, two complementary marks are shown, 8a and 8b. The patterns in the example are centered on the long edges of each of the rectangular items. Each pattern comprises three lines and two spaces, and in the example, different combinations of two line lengths and three space lengths are used. Specifically, the line lengths are 2 mm and 5 mm, and the space lengths are 3 mm, 6 mm and 10 mm. In general, any combination of lengths that produces marks which are sufficiently distinctive for effective recognition by the imaging apparatus is suitable.

The complexity available for the patterns depends on such factors as the precision available from the printing process as a whole, and the material of the item. The numerical or alphanumerical code marked within these patterns may include additional features for consistency checking, such as a parity bit. Additional features include encrypted information, and the codes may make further use redundant data to ease the reading process.

Reference is now made to FIG. 4 which shows a generic description of a four line three space code and a table indicating how the code can be used to generate distinctive patterns for thousands of different sets, of which six examples are given. The code, which is given purely by way of example, is defined by four lines, M1 . . . M4 and three spaces S1 . . . S3, making a total of seven variables. The width of each of the seven variables is allowed to alternate between 0.8 mm and 4 mm in jumps of 0.8 mm. The skilled person will appreciate that there are numerous possibilities for encoding and standard barcode systems involving line thicknesses can be used. If the item is sufficiently thick, say a credit card, then more than one line of a one-dimensional barcode can be included side by side along the edge. Alternatively there is scope for a two-dimensional barcode.

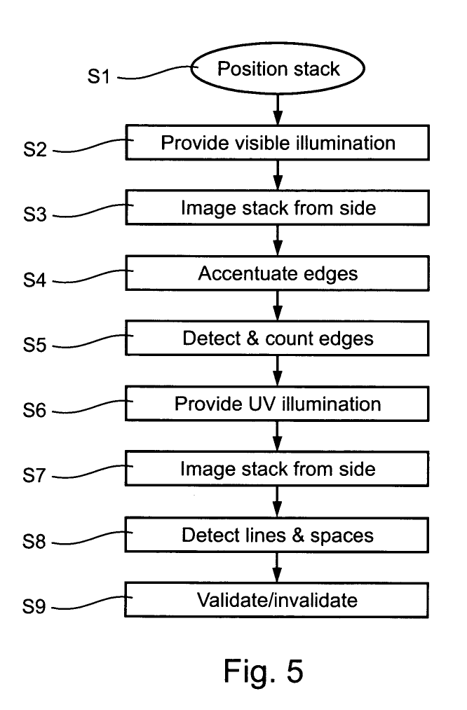

Reference is now made to FIG. 5, which is a simplified flow chart illustrating a procedure for validating a stack of items to determine that the stack comprises a complete set and that no stranger items are present, for example stranger cards in a deck of playing cards. The method comprises S1 placing the stack in position. The stack is made up of one or more decks of cards of the kind described above in which there are provided edge markings. Stage S2 involves viewing the stack from an angle selected to permit the edges of the cards to be seen. Image processing is then carried out over the edges to produce an output indicative of either or both of the number of edges in the stack and the edge markings that are in view. The method comprises using the output to determine whether the set is valid. That is to say the method uses the image to determine that there are the correct number of items and that the items all belong to the same set.

In a preferred embodiment detection of the edges and the edge markings is carried out in two parts. A first part S2 involves viewing the set under first illumination conditions, typically visible light, taking an image of the stack from the side so that the edges of the items are visible in the image—S3, processing the image, using image enhancement including edge enhancement and the like S4 and S5, to allow item recognition, that is obtaining a first output indicative of the number of items present, as described in previous U.S. Pat. No. 5,534,690 to the same assignee. Edge recognition may be used to support item recognition. Simultaneously, the stack is viewed under second illumination conditions, say UV light—S6, and imaged S7. It is preferable to take the two images at the same time, otherwise a difficulty in correlating results may arise if the stack moves between taking of the two images. The second image is analyzed for signs of the lines and spaces of the code—S8, and a second output is obtained which is indicative of edge markings. The set is then either validated if it has the correct number of items all belonging to the same set and no stranger items, or the set is invalidated.

In particular, a single stack may contain items belonging to two or three sets. For example with decks of playing cards, certain games are legitimately played with several decks. Validation in this case comprises determining that a total number of cards is present, which number corresponds to the total of all of the decks intended to be present, and each of the cards has markings corresponding to one of the legitimate sets.

A preferred embodiment produces a specific “foreign item found” output indicating that an item not belonging to the set has been found. Preferably the position of the item is also indicated. If the set is a new deck, so that the order of the cards is a priori known, then the rank and suit of the card can be identified.

Items such as playing cards, credit cards, currency notes, tickets and the like typically have edge-on thicknesses in the sub-millimeter orders of magnitude, and the image recognition process is preferably adapted to work with edges of these typical sizes. Items such as credit cards, smart cards and other plastic cards may have a thickness of around 0.8 mm whereas playing cards may have a thickness in the range of 0.3 mm and banknotes, checks and other papers in the range of 0.1 mm.

Image processing of a stack of items in the above-described range of thicknesses typically comprises image enhancement, followed by item detection, and includes item identification and counting. Image enhancement may include contrast enhancement, edge detection and other kinds of filtering. Finally there is result analysis.

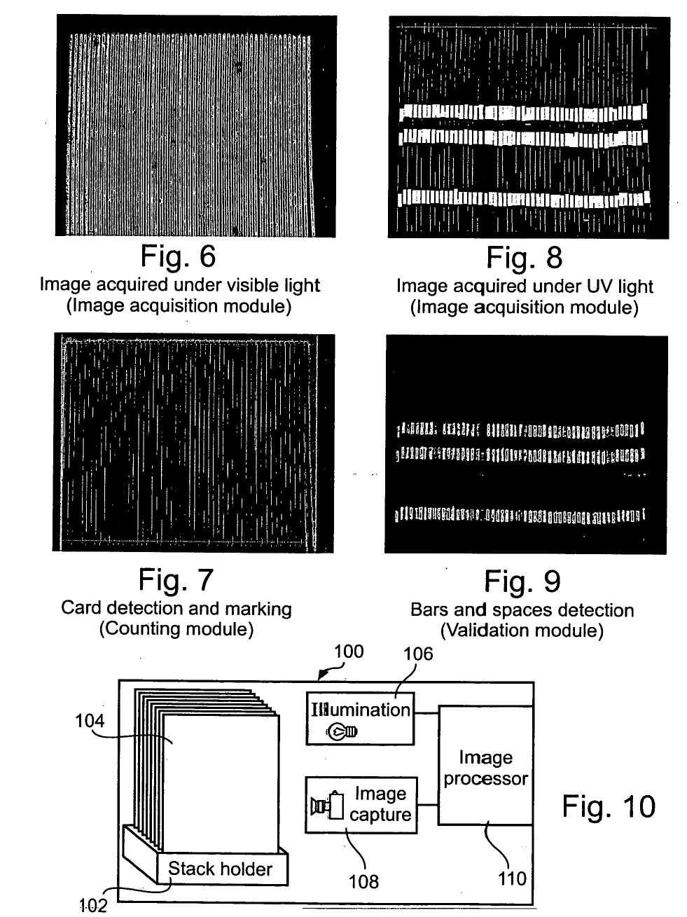

Reference is now made to FIGS. 6-9, which are successive images taken during the process of FIG. 5. FIG. 6 illustrates an image obtained of the stack under visible lighting conditions. FIG. 7 illustrates an image enhanced version of FIG. 6, from which edges can be detected and counted. FIG. 8 illustrates an image acquired under UV illumination and showing the bars and spaces of a three bar two space code. FIG. 9 illustrates an image enhanced version of FIG. 8, from which validation of the codes is possible.

Reference is now made to FIG. 10, which illustrates a stack processing apparatus according to a preferred embodiment of the present invention. Stack processing apparatus 100 comprises a holder 102 for holding a stack 104 of substantially flat items such as cards. The cards extend in a planar direction, and the stack extends vertically, that is at right angles to the planar direction.

Apparatus 100 further comprises an illumination unit 106 for illuminating the stack under predetermined illumination conditions from the planar direction, meaning from the side of the stack. Thus the edges of the items are illuminated, as are the markings on the edges of said items. The illumination unit typically produces both visible light and UV light.

Apparatus 100 further comprises an image capture unit 108 for viewing the stack from the planar direction of the items in the stack. That is to say the image capture unit views the items edge on. The image capture unit captures an image of the items. In the typical case it in fact captures two images of the items, typically very close together one after the other, one under visible lighting as in FIG. 6 and the second under UV lighting as in FIG. 8. Alternatively, if the markings are visible under normal illumination conditions then only a single illumination phase and image capture is required to obtain all of the information. Alternatively, if color image capture is used, then the two types of illumination can be applied together and different filters used to obtain the different information.

It is noted that when using UV lighting, a UV blocking filter should be fitted over the image capture unit so as not to allow direct UV radiation into the camera, but only the fluorescence as emitted by the subject under the UV radiation.

The image capture unit is followed by an image processing unit 110 which processes the image to obtain data from the edges and the illuminated markings. Processing typically involves enhancing the two images and then extracting the number of edges or the code data. The set, for example a deck of cards, may then be validated or invalidated.

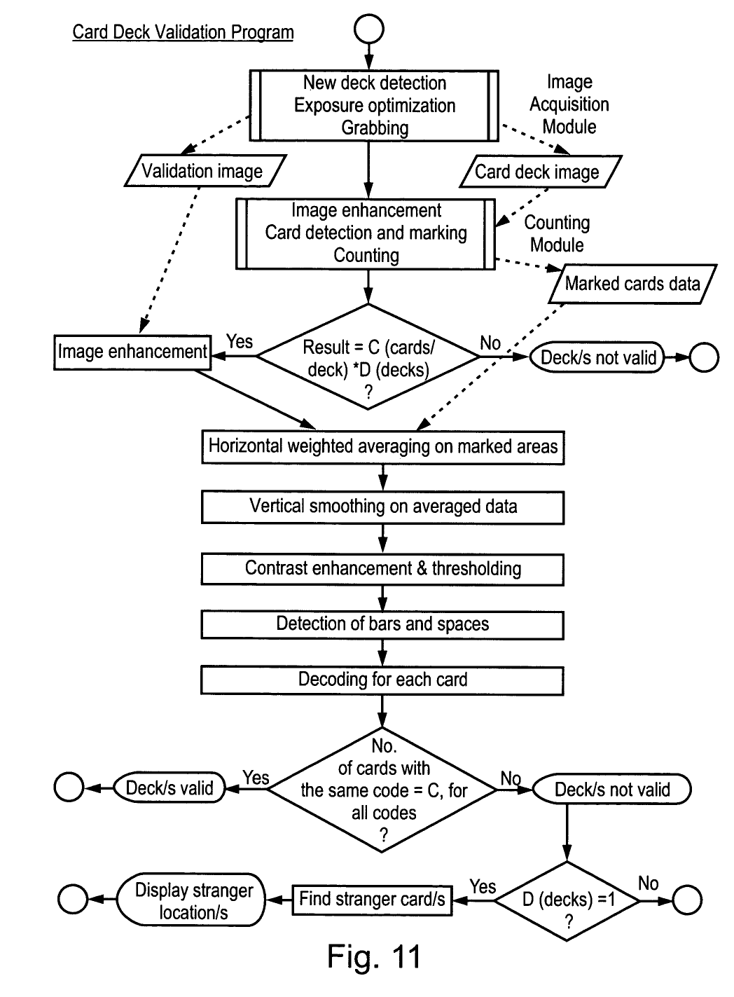

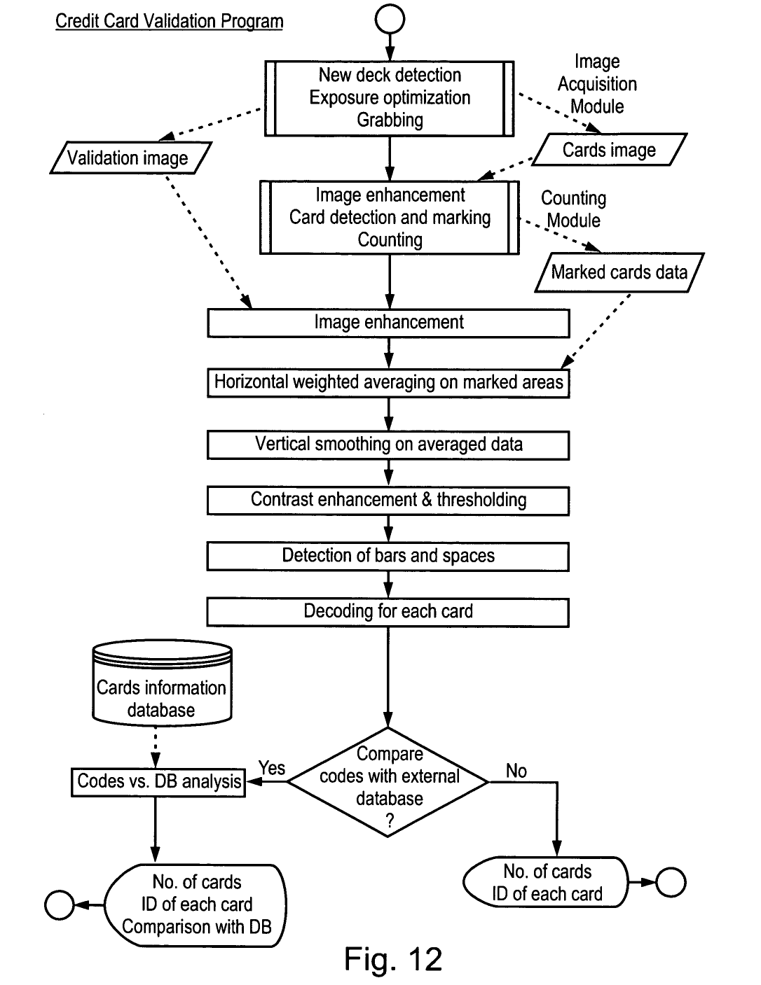

Reference is now made to FIG. 11 which is a simplified diagram illustrating a more detailed version of the flow chart of FIG. 5. In FIG. 11 the image acquisition module firstly acquires two images, one for the codes and one for the number of items, say cards. It will be appreciated that if the codes are visible under ordinary light then a single image may suffice for both. Image enhancement is applied to the image for the number of cards. The image for the number of cards is then subjected to item counting. If the correct number of items (C items per set times D sets) is detected then the code image is enhanced. Horizontal averaging of the areas marked by the codes is applied together with vertical smoothing for elimination of noise and improvement of the image. Contrast enhancement and thresholding are also applied so that the image of FIG. 8 is converted to that of FIG. 9. Then detection of bars and spaces occurs and each item is separately decoded. The number of cards in each set is compared with an expected total C for each set. Then the number of sets (as represented by the number of codes present) is compared with the number of expected sets. If the correct number of items belong to each set then the stack is declared to be valid. If desired the system can be made to check that an expected set is present. If on the other hand, either the wrong number of items is found or one or more of the items do not belong to the expected sets then the stranger items are located and their location is displayed. FIG. 11 specifically relates to the case in which the sets are decks of playing cards, and the items are not individually identifiable except as being members of a given deck. However reference is now made to FIG. 12, which is the same as FIG. 11, with the exception that it refers to the case in which the items are individually identifiable and may or may not belong to a set. Stages that are the same as in FIG. 11 are not referred to again except as necessary for understanding the present embodiment. In FIG. 12 the illumination and image gathering stages are the same. The total number of items may optionally be determined as before, but more importantly the codes on the individual items are determined as before. However validation of sets is optional as the items do not necessarily form sets. From an alternative point of view, the credit card case is a particular case of the above example where there is one member per set. The individual items are thus decoded and the codes are tested against a database to determine that the expected items are present. Alternatively the items are simply decoded and a list is made of the number of cards and or the individual codes found. Returning to the case of playing cards, and during manufacture of the cards, the edge markings are preferably printed on the cards during or after printing of the surfaces of the cards and prior to packing of the cards into decks. Typically the set of cards is checked, using for instance face recognition, prior to applying edge markings.

It is noted that the invention is not merely applicable to items to which encoding is specifically added. Certain items may intrinsically have features which can be viewed from the side and used in the edge-on identification process of the present embodiments. An example is the case of banknotes, in which many banknotes have metallic or plastic strips which are visible at the edges. With some currencies the position of the strip along the edges indicates the denomination of the banknote. Additionally or alternatively the color of the strip under UV illumination indicates the denomination of the banknote.

In the above description a one-dimensional bar-code has been described. Furthermore a number of specific customized one-dimensional bar codes have been described. It is noted however that the present embodiments also extend to the use of existing common including commercial barcode systems. Furthermore, particularly with thicker items such as credit and smart cards there is room for a two-dimensional barcode, and numerous kinds of two-dimensional bar-codes are known.

It is expected that during the life of this patent many relevant imaging devices, illumination systems and image processing systems will be developed and the scopes of these and other terms herein, are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method of validating stacked substantially flat items, comprising:
stacking items having markings identifiable from an edge,
viewing said stack from at least one angle selected so that said markings of said items are in view,
capturing an image from said at least one angle,
carrying out image processing over said image to produce at least one output indicative of one of edges and edge markings in view, and
using said output to obtain information of items in said stack.

2. The method of claim 1, comprising carrying out said viewing of said stack under predetermined illumination conditions.

3. The method of claim 1, comprising viewing said stack under at least first illumination conditions to obtain a first output indicative of a number of items, and viewing said stack under at least second illumination conditions to obtain a second image indicative of said markings.

4. The method of claim 3, wherein one of said illumination conditions comprises illumination under visible light and a second of said illumination conditions comprises illumination under ultra-violet light.

5. The method of claim 1, wherein a plurality of said items belong to a respective set, and wherein said markings comprise corresponding markings applied to each item of a respective set, thereby to allow items not belonging to said respective set to be readily identifiable.

6. The method of claim 1, wherein said edge markings are unique to individual items.

7. The method of claim 5, wherein correspondence between edge markings comprises respective edge marks in said sets having corresponding lengths.

8. The method of claim 5, wherein correspondence between edge markings comprises respective edge marks in said sets having corresponding positions along respective edges.

9. The method of claim 5, wherein correspondence between edge markings comprises respective edge marks in said sets having corresponding colors under predetermined illumination conditions.

10. The method of claim 5, wherein correspondence between edge markings comprises respective edge marks in said sets having corresponding intensities under predetermined illumination conditions.

11. The method of claim 5, wherein correspondence between edge markings comprises respective edge marks in said sets having corresponding patterns.

12. The method of claim 11, wherein said edge markings comprise a one-dimensional or two-dimensional bar code.

13. The method of claim 5, wherein said items are of rectangular shape, allowing four orientations within a stack, and wherein said markings are equally visible from any given viewing angle irrespective of which of said four orientations a respective item assumes.

14. The method of claim 5, wherein said edge markings comprise an ink viewable only under predetermined illumination conditions.

15. The method of claim 14, wherein each set has a predetermined number of members.

16. The method of claim 15, wherein said determining whether said set is valid comprises determining that said predetermined number of items is present and that each item present has markings corresponding to said set.

17. The method of claim 15, wherein a respective stack comprises items belonging to a plurality of sets, and said determining comprises determining that a total number of items is present which number corresponds to said predetermined number for each of said sets totaled together, and wherein each of said items has markings corresponding to one of said plurality of sets.

18. The method of claim 16, further comprising producing a foreign item output indicating the presence of an item not belonging to said set.

19. The method of claim 18, wherein said foreign item output additionally indicates a location of said item not belonging to said set.

20. The method of claim 1, wherein said items are at least one of paper or cardboard or plastic items.

21. The method of claim 1, wherein said items have thicknesses in the sub-millimeter of a millimeter order of magnitude.

22. The method of claim 1, wherein said image processing comprises image enhancement and item detection.

23. The method of claim 1, wherein said image processing comprises detection of bars and spaces within said edge markings.

24. The method of claim 20, wherein said sets are decks of playing cards.

25. The method of claim 1, wherein said items are flat monetary-value-bearing items.

26. The method of claim 1, wherein said items are at least one of credit cards, debit cards, smart cards, electronic purses, checks, travelers checks, banknotes, bonds, identity cards, driving licenses, passports, passport pages, security paper, official documents, membership cards, travel cards, tickets and playing cards.

27. The method of claim 1, wherein said items have at least two oppositely facing edges and complementary edge markings on each of said oppositely facing edges so that an orientation of said item is detectable.

28. A set of items, each item in said set having edges, and a marking on at least one of said edges and viewable edge on, respective markings corresponding within said set so that items can be identified as belonging or not belonging to said set on the basis of said marking.

29. The set of claim 28, wherein said marking is visible only under predetermined illumination conditions.

30. The set of claim 28, wherein said marking is invisible under illumination over the visible part of the spectrum.

31. The set of claim 28, wherein each item has at least two oppositely facing edges and wherein markings are placed on each of said oppositely facing edges.

32. The set of claim 31, comprising complementary markings on each of said oppositely facing edges.

33. The set of claim 28, wherein each item has at least four edges, and wherein markings are placed on at least two of said edges.

34. The set of claim 33, wherein each said markings on at least two of said edges are identical.

35. The set of claim 33, wherein each of said markings on at least two of said edges are complementary.

36. The set of claim 28, wherein correspondence comprises a position of said marking along a respective edge.

37. The set of claim 28, wherein correspondence comprises a length of said marking along a respective edge.

38. The set of claim 28, wherein correspondence comprises a color of said marking under given illumination conditions.

39. The set of claim 28, wherein correspondence comprises an intensity of said marking under given illumination conditions.

40. The set of claim 28, wherein correspondence comprises a corresponding pattern in said markings.

41. The set of claim 40, wherein said marking comprises a barcode

42. Stack processing apparatus comprising:
a holder for holding a stack of substantially flat items extending in a planar direction and having edges, said stack extending vertically from said planar direction, and at least one of said items comprising a marking at one of said edges,
an illumination unit for illuminating said stack under predetermined illumination conditions from an angle at which said edge-on markings on edges of said items can be illuminated, an image capture unit for viewing said stack from an angle at which said edge-on markings can be detected so as to view said items edge on and capture an image thereof, and
an image processing unit for processing said image to obtain data from said edges and said illuminated markings.

43. Apparatus according to claim 42, wherein said image processing apparatus is operable to use said data to determine a total number of items in said stack and to identify said items from said edge-on visible markings.

44. Apparatus according to claim 42, wherein said illumination unit is configured to provide a predetermined illumination condition.

45. Apparatus according to claim 42, wherein said illumination unit is configured for providing at least two illumination conditions, comprising first illumination conditions to obtain a first image indicative of edges, and second illumination conditions to obtain a second image indicative of edge markings.

46. Apparatus according to claim 45, wherein one of said illumination conditions comprises illumination under visible light and a second of said illumination conditions comprises illumination under ultra-violet light.

47. Apparatus according to claim 42, wherein said items are organized in sets, and wherein said markings correspond between each item of a respective set, thereby to allow items belonging to said respective set to be readily identifiable.

48. Apparatus according to claim 47, wherein correspondence between edge markings comprises respective edge marks in said sets having corresponding lengths.

49. Apparatus according to claim 47, wherein correspondence between edge markings comprises respective edge marks in said sets having corresponding positions along respective edges.

50. Apparatus according to claim 47, wherein correspondence between edge markings comprises respective edge marks in said sets having corresponding colors under predetermined illumination conditions.

51. Apparatus according to claim 47, wherein correspondence between edge markings comprises respective edge marks in said sets having corresponding patterns.

52. Apparatus according to claim 51, wherein said edge markings comprise a barcode.

53. Apparatus according to claim 47, wherein said items are of rectangular shape, allowing four orientations within a stack, and wherein said edge markings are arranged such that markings are equally visible from any given viewing angle irrespective of which of said four orientations a respective item assumes.

54. Apparatus according to claim 47, wherein each set has a predetermined number of members.

55. Apparatus according to claim 54, wherein said image processor comprises a validator for using said image processing to determine whether item sets are valid, and wherein said determining whether said set is valid comprises determining that said predetermined number of items is present and that each item present has markings corresponding to said set.

56. Apparatus according to claim 55, wherein a respective stack comprises items belonging to a plurality of sets, and said determining comprises determining that a total number of items is present, which number corresponds to said predetermined number for each of said sets totaled together, and wherein each of said items has markings corresponding to one of said plurality of sets.

57. Apparatus according to claim 55, further comprising producing a foreign item output indicating the presence of an item not belonging to a respective set.

58. Apparatus according to claim 57, wherein said foreign item output additionally indicates a location of said item not belonging to said respective set.

59. Apparatus according to claim 42, wherein said items comprise at least one of paper or card or plastic items.

60. Apparatus according to claim 42, wherein said items have thicknesses in the sub-millimeter order of magnitude.

61. Apparatus according to claim 42, wherein said image processor is adapted to carry out item detection.

62. Apparatus according to claim 61, wherein said item detection comprises image enhancement.

63. Apparatus according to claim 59, wherein said items are playing cards being parts of decks.

64. Apparatus according to claim 42, wherein said items have at least two edges and complementary edge markings on each of said oppositely facing edges, said image processor being able to use said complementary markings to detect an orientation of said item within said stack.

65. A method of modifying substantially flat items having faces and edges, for identification of respective items whilst stacked, comprising:
providing said substantially flat items, and
applying markings along at least one edge of each item.

66. The method of claim 65, wherein said marking is provided to a respective face such as to be visible from an edge under at least predetermined illumination conditions.

67. The method of claim 65, wherein said marking is applied to one of said edges of said item.

68. The method of claim 65, wherein said marking is not visible under illumination from the visible part of the spectrum.

69. The method of claim 65, wherein each item has at least two oppositely facing edges and comprising providing complementary marks on said at least two oppositely facing edges so that an orientation of said item within a stack is detectable.

70. The method of claim 65, wherein said items belong to sets, and comprising providing corresponding marks to each item within a given set and non-corresponding marks for different sets.

71. The method of claim 65, comprising providing each item in the same set with a mark having a corresponding length.

72. The method of claim 65, comprising providing each item in the same set with a mark having a corresponding position on said edge.

73. The method of claim 65, comprising providing each item in the same set with a mark having a corresponding color under given illumination conditions.

74. The method of claim 65, comprising providing each item in the same set with a mark having a corresponding intensity under given illumination conditions.

75. The method of claim 65, comprising providing each item in the same set with a mark having a corresponding pattern.

76. The method of claim 75, wherein said pattern comprises a barcode.
